(19) United States
(12) Patent Application Publication
(10) Pub. No.: US 2026/0214699 A1
(43) Pub. Date: Jul. 23, 2026

(54) SEMI-STATIC CHANNEL ACCESS METHOD IN UNLICENSED BAND

(71) Applicant: PURPLEVINE INNOVATION COMPANY LIMITED, Hongkong (CN)

(72) Inventor: Chun-Che CHIEN, Hongkong (CN)

(73) Assignee: PURPLEVINE INNOVATION COMPANY LIMITED, Hongkong (CN)

(21) Appl. No.: 19/139,818

(22) PCT Filed: Dec. 15, 2023
(86) PCT No.: PCT/CN2023/139129

§ 371 Date: Jun. 16, 2025

Related U.S. Application Data
(60) Provisional application No. 63/387,806, filed on Dec. 16, 2022.

(51) Int. Cl. H04W 74/0808; H04W 92/18

(52) U.S. Cl. CPC H04W 74/0808; H04W 92/18

(57) ABSTRACT

A semi-static channel access method in unlicensed band is provided. A user equipment (UE) receives a configuration of at least one set of Fixed Frame Period (FFP) parameters and derives a channel occupancy time (COT) initiator of a COT initiated based on a set of FFP parameters when semi-static channel access for sidelink (SL) transmission is activated. The UE transmits a scheduled SL burst within the COT initiated by the derived COT initiator if at least one transmission condition is met.

### BACKGROUND OF DISCLOSURE

### 1. Field of Disclosure

The present disclosure relates to the field of communication systems, and more particularly, to a semi-static channel access method for sidelink on unlicensed bands.

### 2. Description of Related Art

Development of a work item (WI) on NR sidelink evolution in the Third Generation Partnership Project (3GPP) includes objectives for sidelink operation in unlicensed spectrum. The objectives for both mode 1 and mode 2 sidelink operation were specified, with Uu operation for mode 1 limited exclusively to licensed spectrum. The study encompasses the following aspects:
1. Channel Access Mechanisms: Reuse of channel access mechanisms from NR-U for sidelink unlicensed operation is mandated. The assessment of the applicability of sidelink resource reservation from Rel-16/Rel-17 to sidelink unlicensed operation is required within the boundaries of unlicensed channel access mechanisms and operation. No specific enhancements for Rel-17 resource allocation mechanisms are mandated. If the existing NR-U channel access framework doesn't support the required SL-U functionality, appropriate recommendations will be made by working groups for RAN approval.
2. Physical Channel Design Framework: Changes to NR sidelink physical channel structures and procedures for operation on unlicensed spectrum are necessary. The existing NR sidelink and NR-U channel structure will serve as the baseline. No specific enhancements for existing NR SL feature(s) are outlined.
3. Focus of the Study: The study should concentrate on FR1 unlicensed bands (n46 and n96/n102).

### Technical Problem

During sidelink unlicensed operation, gNB (e.g., BS 20a) refrains from executing Type 1 channel access for initiating and sharing channel occupancy, Type 2 channel access for sharing an initiated channel occupancy, as well as semi-static channel access procedures for accessing an unlicensed channel.

Many issues of semi-static channel access for Frame Based Equipment (FBE) and Load Based Equipment (LBE) in SL-U should be addressed, including signaling, protocols, and procedures.

Hence, a channel access method for sidelink on unlicensed bands (SL-U) is desirable.

### SUMMARY

An object of the present disclosure is to propose a base station and a semi-static channel access method.

In a first aspect, an embodiment of the invention provides a semi-static channel access method in unlicensed band for execution by a user equipment (UE), comprising:
receiving a configuration of at least one set of fixed frame period (FFP) parameters;
deriving a channel occupancy time (COT) initiator of a COT initialized based on a set of FFP parameters when semi-static channel access for sidelink (SL) transmission is activated; and
transmitting a scheduled SL burst within the COT initiated by the derived COT initiator if at least one of transmission condition is met.

In a second aspect, an embodiment of the invention provides a user equipment (UE) comprising a processor configured to call and run a computer program stored in a memory, to cause a device in which the chip is installed to execute the disclosed method and any combination of embodiments of the disclosed method.

In a third aspect, an embodiment of the invention provides a semi-static channel access method executable in a base station, comprising:
transmitting a configuration of at least one set of fixed frame period (FFP) parameters;
transmitting scheduling information of a sidelink (SL) burst within a channel occupancy time (COT) of an FFP associated with the at least one set of FFP parameters; and
receiving SL hybrid automatic repeat request (HARQ) feedback that responds to transmission of the scheduled SL burst.

In a fourth aspect, an embodiment of the invention provides a base station comprising a processor configured to call and run a computer program stored in a memory, to cause a device in which the processor is installed to execute the disclosed method.

The disclosed method may be programmed as computer executable instructions stored in non-transitory computer readable medium. The non-transitory computer readable medium, when loaded to a computer, directs a processor of the computer to execute the disclosed method.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as a computer program product, that causes a computer to execute the disclosed method.

The disclosed method may be programmed as a computer program. that causes a computer to execute the disclosed method.

### Advantageous Effects

Embodiments of the disclosure provide a semi-static channel access method for SL-U.

Some embodiments of the disclosure allow a receiving UE to send SL hybrid automatic repeat request (HARQ) feedback to a transmitting UE. The transmission occasion of the HARQ feedback may be in a reserved resource indicated by the receiving UE or transmitting UE in resource reservation information. The receiving UE may initiate a channel occupancy time (COT) or share a COT initiated by the transmitting UE for the HARQ feedback.

The semi-static channel access method allows vehicles to communicate with each other in the unlicensed band using sidelink. This method improves the reliability and efficiency of the sidelink communication by reducing the interference and collisions among the vehicles.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field may obtain other figures according to these figures without paying the premise.

FIG. 1 illustrates a schematic view of a telecommunication system.

FIG. 2 illustrates a schematic view showing an embodiment of the disclosed method performed by a base station.

FIG. 3 illustrates a schematic view showing an embodiment of the disclosed method performed by a UE.

FIG. 4 illustrates a schematic view showing an example of a signaling flow that demonstrates the relationship between a gNB and three UEs for Mode 1 resource allocation based on semi-static channel access.

FIG. 5 illustrates a schematic view showing a COT with resource allocation and resource reservation for semi-static channel access.

FIG. 6 illustrates a schematic view showing a procedure of Mode 2 resource allocation and resource reservation for semi-static channel access associated with Embodiment B-1.

FIG. 7 illustrates a schematic view showing an example of Mode 2 resource allocation for semi-static channel access where UEs share the same FFP parameters.

FIG. 8 illustrates a schematic view showing a user equipment (UE).

FIG. 9 illustrates a schematic view showing a network node.

FIG. 10 illustrates a schematic view showing a chip or executing the disclosed method in a UE.

FIG. 11 illustrates a schematic view showing a chip or executing the disclosed method in a network node.

FIG. 12 illustrates a schematic view showing a system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Embodiments of the disclosure relates to the field of New Radio (NR) sidelink resource allocation procedure in unlicensed band and address issues regarding semi-static channel access for SL-U.

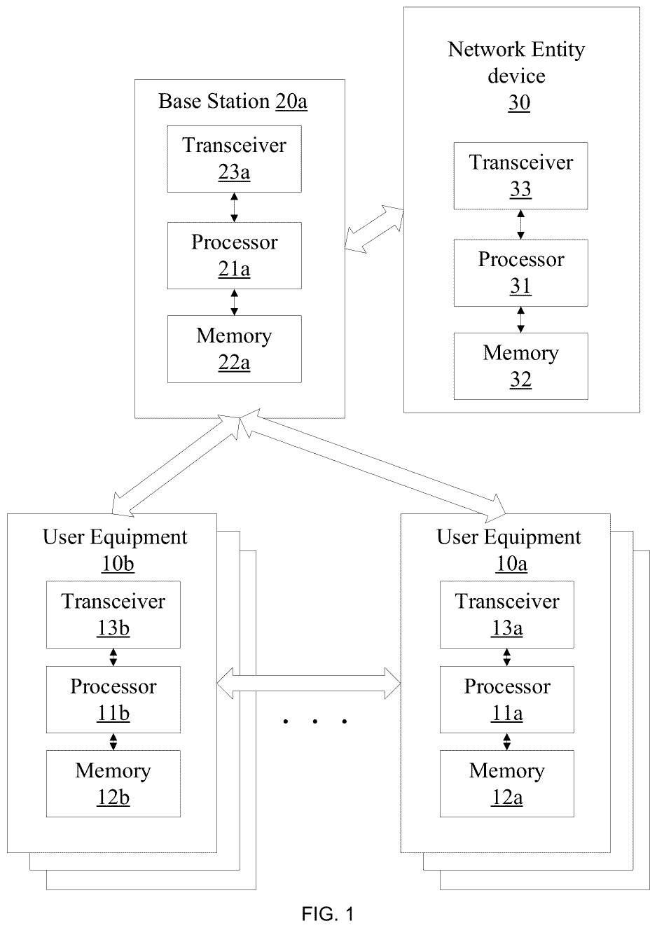

With reference to FIG. 1, a telecommunication system including a user equipment (UE) 10a, a UE 10b, a base station (BS) 20a, and a network entity device 30 executes the disclosed method according to an embodiment of the present disclosure. FIG. 1 is shown for illustrative not limiting, and the system may comprise more UEs, BSs, and core network (CN) entities. Connections between devices and device components are shown as lines and arrows in the FIGs. The UE 10a may include a processor 11a, a memory 12a, and a transceiver 13a. The UE 10b may include a processor 11b, a memory 12b, and a transceiver 13b. The base station 20a may include a processor 21a, a memory 22a, and a transceiver 23a. The network entity device 30 may include a processor 31, a memory 32, and a transceiver 33. Each of the processors 11a, 11b, 21a, and 31 may be configured to implement proposed functions, procedures and/or methods described in the description. Layers of radio interface protocol may be implemented in the processors 11a, 11b, 21a, and 31. Each of the memory 12a, 12b, 22a. and 32 operatively stores a variety of programs and information to operate a connected processor. Each of the transceivers 13a, 13b, 23a, and 33 is operatively coupled with a connected processor, and transmits and/or receives radio signals or wireline signals. The UE 10a may be in communication with the UE 10b through a sidelink. The base station 20a may be an eNB, a gNB, or one of other types of radio nodes, and may configure radio resources for the UE 10a and UE 10b.

Each of the processors 11a. 11b, 21a, and 31 may include an application-specific integrated circuit (ASICs), other chipsets, logic circuits and/or data processing devices. Each of the memory 12a, 12b, 22a. and 32 may include read-only memory (ROM), a random access memory (RAM), a flash memory, a memory card, a storage medium and/or other storage devices. Each of the transceivers 13a, 13b, 23a, and 33 may include baseband circuitry and radio frequency (RF) circuitry to process radio frequency signals. When the embodiments are implemented in software, the techniques described herein may be implemented with modules, procedures, functions, entities, and so on, that perform the functions described herein. The modules may be stored in a memory and executed by the processors. The memory may be implemented within a processor or external to the processor, in which those may be communicatively coupled to the processor via various means are known in the art.

The network entity device 30 may be a node in a CN. CN may include LTE CN or 5G core (5GC) which includes user plane function (UPF), session management function (SMF), mobility management function (AMF), unified data management (UDM), policy control function (PCF), control plane (CP)/user plane (UP) separation (CUPS), authentication server (AUSF), network slice selection function (NSSF), and the network exposure function (NEF).

An example of the UE in the description may include one of the UE 10a or UE 10b. An example of the base station in the description may include the base station 20a. Sidelink (SL) transmission of a control signal or data may be a transmission operation from a UE to another UE. Uplink (UL) transmission of a control signal or data may be a transmission operation from a UE to a base station. Downlink (DL) transmission of a control signal or data may be a transmission operation from a base station to a UE. A DL control signal may comprise downlink control information (DCI) or a radio resource control (RRC) signal, from a base station to a UE.

The disclosure presents embodiments focusing on semi-static channel access for Frame Based Equipment (FBE) in SL-U. Notably, some of these mechanisms can also be applied to dynamic channel access for Load Based Equipment (LBE) in SL-U.

Within NR V2X, two resource allocation modes exist for sidelink communications:
1. Mode 1 corresponds to a centralized scheduling scheme, where the gNB (e.g., BS 20a) schedules radio resources for sidelink transmissions.
2. Mode 2 corresponds to a distributed scheduling scheme, where the user equipment (UE) autonomously selects radio resources from a pool configured by the gNB (e.g., BS 20a) before executing sidelink transmissions.

Mode 1 resource allocation is confined to scenarios where UEs operate within the coverage of the gNB (e.g., BS 20a). Conversely, Mode 2 resource allocation is determined and executed by a UE, functioning within or outside of the gNB (e.g., BS 20a)'s coverage.

In NR Vehicle-to-Everything (V2X), physical sidelink control channel (PSCCH) serves to carry sidelink control information (SCI), the physical sidelink shared channel (PSSCH) transmits sidelink data, and the physical sidelink feedback channel (PSFCH) conveys hybrid automatic repeat request (HARQ) feedback information in response to sidelink data received on the PSSCH.

The Sidelink Control Information (SCI) is responsible for scheduling the resources conveyed by the Physical Sidelink Shared Channel (PSSCH) associated with a Transport Block (TB) and providing the necessary information for decoding the TB. Unlike Long Term Evolution (LTE) V2X, where the SCI is exclusively transmitted in the Physical Sidelink Control Channel (PSCCH), NR V2X employs a two-stage transmission for the SCI. This entails the transmission of the first stage SCI through the PSCCH and the second stage SCI through the corresponding PSSCH.

The first stage of Sidelink Control Information (SCI) serves to indicate the frequency resources allocated for the Physical Sidelink Shared Channel (PSSCH) and specifies the resource reservation for up to two retransmissions of a Transport Block (TB). Additionally, the first stage SCI carries essential details such as the Modulation and Coding Scheme (MCS) of the associated PSSCH, priority of the associated PSSCH, and the SCI format and size of the second stage SCI.

On the other hand, the second stage SCI carries information vital for decoding the PSSCH, supporting Hybrid Automatic Repeat Request (HARQ) feedback, and facilitating Channel State Information (CSI) reporting. This stage specifies a source ID, a destination ID, and whether HARQ feedback is enabled for the received PSSCH. The destination ID indicates the intended receiver of the TB, either a specific receiver UE (Rx UE) for unicast or a group identifier for groupcast. The source ID allows an Rx UE to identify the transmitter UE (Tx UE) for HARQ feedback conveyed on the PSFCH. Furthermore, the second stage SCI includes a New Data Indicator (NDI), Redundancy Version (RV), and an HARQ process ID associated with the corresponding TB.

Splitting of the SCI into two stages serves a specific purpose: UEs, other than the Rx UE, can decode only the first stage SCI in the PSCCH for channel sensing and determine whether a resource is reserved by other Tx UEs. Meanwhile, the second stage SCI provides additional information on TB decoding and feedback specifically for the Rx UE.

To facilitate sidelink radio access to unlicensed spectrum, the introduction of Listen Before Talk (LBT) and channel occupancy time (COT) acquisition or COT sharing can be implemented in both Mode 1 and Mode 2 resource allocation schemes within the PC5 interface. The PC5 interface serves as a reference point between UEs for direct UE-to-UE direct communication, as defined in 3GPP.

For Mode 1 resource allocation, UEs are required to execute a channel access procedure, specifically LBT, before engaging in sidelink transmission on the scheduled resources. In this scenario, the gNB (e.g., BS 20a) evaluates the channel based on channel measurements and report(s) from the UE. The gNB (e.g., BS 20a) may then schedule sidelink transmissions for UEs, utilizing either licensed or unlicensed spectrum from the Uu interface to allocate sidelink resources within the unlicensed spectrum of the PC5interface.

In the case of Mode 2 resource allocation, UEs must conduct channel sensing, resource selection, and a channel access procedure before initiating sidelink transmission on the unlicensed spectrum. To prevent resource collisions in a shared pool within an unlicensed band, the SCI indicates a reservation of sidelink resources for the ongoing or future sidelink transmission(s) in NR-V2X. This reservation information in the SCI allows other sidelink UEs to monitor the SCI, determining whether a sidelink resource in the pool is currently occupied or available for sidelink transmission.

By incorporating the resource reservation mechanism for unlicensed spectrum scenarios in SL-U. the Tx UE follows a sequence of actions. After identifying candidate resources using the resource reservation information and conducting resource selection, the Tx UE engages in Listen Before Talk (LBT) to assess channel availability before the selected resource. Subsequently, the Tx UE acquires a Channel Occupancy Time (COT) by initiating a COT for its own sidelink transmission to the Rx UE(s) or uses the shared COT received from other sidelink UEs.

In NR-U, for unlicensed spectrum access, two supported channel access modes are Load-Based Equipment (LBE) and Frame-Based Equipment (FBE) modes. LBE is synonymous with a dynamic channel access mode, while FBE is referred to as a semi-static channel access mode. In the LBE channel access mode, a UE performs LBT whenever having data waiting for transmission in the buffer and initiates a COT for transmissions upon successful LBT. In the FBE channel access mode, a UE contends for the channel based on LBT at synchronized frame boundaries according to a fixed frame period (FFP). For each FBE device, a specific FFP value from (1 ms, 2 ms, 2.5 ms, 4 ms, 5 ms, 10 ms) can be assigned.

A Channel Occupancy Time (COT) associated with a successful LBT in FBE operation commences at the beginning of the FFP, with a duration not exceeding 95% of the FFP. The COT is succeeded by an idle period until the initiation of the next FFP, ensuring that the idle period duration is at least 5% of the FFP but not less than 100 μs.

In the context of LBT-based channel access, once a UE initiates a channel occupancy time (COT) following a successful Type 1 LBT, the duration for continuous transmission can extend up to the maximum COT (mCOT). The specific value of mCOT is determined based on the Channel Access Priority Class (CAPC) adopted by the UE.

Introducing burst transmission, where the gaps between any two consecutive transmissions are restricted to a maximum of 16 μs within a COT, can enhance channel access efficiency and mitigate the risk of losing channel occupancy due to LBT failures or frequent LBT procedures within the COT. Given that a UE can access as many consecutive resources as possible within a COT. burst transmission emerges as a promising scheme for high-data-rate sidelink (SL) transmission. This is particularly relevant for applications such as high-data-rate direct vehicle communication, augmented reality/virtual reality (AR/VR) gaming, video streaming in smart home IoT networks, and more.

The implementation of burst transmission can be achieved through multi-consecutive slots transmission (MCSt), involving the transmission of multiple consecutive slots within a COT for the same Transport Block (TB) or different TBs. These multi-consecutive slots can be transmitted by a UE initiating the COT (initiating UE) and/or by a UE that uses the shared COT (responding UE) within the same COT period.

The disclosure presents embodiments illustrating the operation of both Mode 1 and Mode 2 resource allocations, with a particular focus on the semi-static channel access mode. In the case of Mode 1 resource allocation, a gNB (e.g., BS 20a), relying on information provided by UEs, can schedule resources for one or more UEs. The UEs are then required to determine whether they are acting as initiating UEs or responding UEs of a COT that is associated with a set of FFP parameters.

For Mode 2 resource allocation, after a successful LBT procedure in the semi-static channel access, an initiating UE (e.g., one of UE 10a or UE 10b) has the capability to identify and select available candidate resources based on the starting locations of one or more associated FFPs. This selection is crucial for scheduling sidelink (SL) traffic and providing resource reservation information to one or more UEs. On the other hand, the target receiver of the initiating UE (e.g., one of UE 10a or UE 10b) has the option to either share an initiated COT initiated by the initiating UE (e.g., one of UE 10a or UE 10b) or, if feasible, initiate its own COT to access an SL channel within the designated COT.

A channel access method is desirable to support two different modes of channel access schemes, including dynamic channel access designed for LBE and semi-static channel access tailored for FBE.

The advantages of employing semi-static channel access for FBE include:
1. Applicability in controlled scenarios in absence of other technologies is ensured, especially in environments where interference from other Radio Access Technologies (RAT) can be controlled, such as in an Industry Internet of Things (IIOT) scenario.
2. Alignment of FFPs among SL devices leads to increased resource efficiency by allowing the multiplexing of transmissions from different devices.
3. The alignment of FFPs among SL devices helps in avoiding inter-UE collisions or blocking, consequently enhancing SL throughput.
4. The periodic nature of semi-static channel access is advantageous for power saving by reducing channel sensing durations.

Embodiments of the disclosure offer Mode 1 and Mode 2 resource allocation procedures according to the structure of FFPs to achieve semi-static channel access in SL-U.

Advantageous Effects of the embodiments include enhanced resource utilization, power efficiency. and throughput for sidelink scenarios, particularly in situations where the unlicensed spectrum is exclusively dedicated to specific technologies. This is beneficial for applications such as ultra-reliable low-latency communication (URLLC) in industrial internet of things (IIoT) networks or augmented reality/virtual reality (AR/VR) applications in home networks.

Please note that the term “resource” in the description pertains to, at the very least, time-frequency radio resources. The designation “Rx UE” signifies a receiving UE, while “Tx UE” denotes a transmitting UE. A UE responsible for initiating a COT is termed an initiating UE. Conversely, a responding UE (e.g., one of UE 10b or UE 10a) shares a COT initiated by an initiating UE. The term “initiating UE” can be used interchangeably with “initiator UE.”

Each layer, such as the physical layer, MAC layer, and others, may manifest as a software program module or an integrated circuit (IC) entity or unit designed to perform the corresponding functions according to 3GPP-related standards.

Throughout the description, two UEs are used as an example, referred to as a UE and another UE, to illustrate multiple embodiments. It's important to note that these embodiments are not confined to the example of two UEs. The concepts are applicable to scenarios involving more than two UEs.

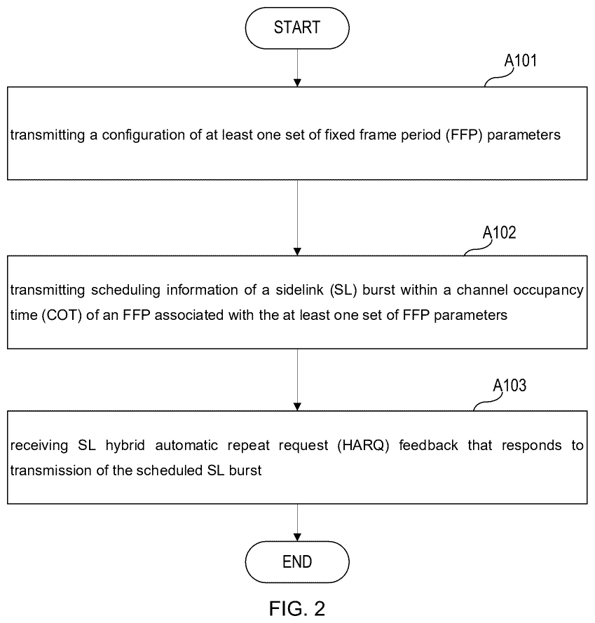

With reference to FIG. 2, a base station(e.g., 20a) executes an embodiment of a semi-static channel access method in unlicensed band.

The base station transmits a configuration of at least one set of fixed frame period (FFP) parameters (A101).

The base station transmits scheduling information of a sidelink (SL) burst within a channel occupancy time (COT) of an FFP associated with the at least one set of FFP parameters (A102).

The base station receives SL hybrid automatic repeat request (HARQ) feedback that responds to transmission of the scheduled SL burst (A103).

In some embodiments of the disclosure, the at least one set of FFP parameters is configured for a first UE, the COT is initiated by the first UE according to the at least one set of FFP parameters, the scheduled SL burst is transmitted form the first UE to a second UE, and the SL HARQ feedback is received from the second UE.

In some embodiments of the disclosure, a resource location of scheduled SL burst is aligned with a starting point of an FFP configured in the at least one set of FFP parameters.

In some embodiments of the disclosure, the COT is initiated by a COT initiator, and the COT initiator is indicated based on an indication transmitted by the base station. For example, the COT initiator is indicated in a DCI.

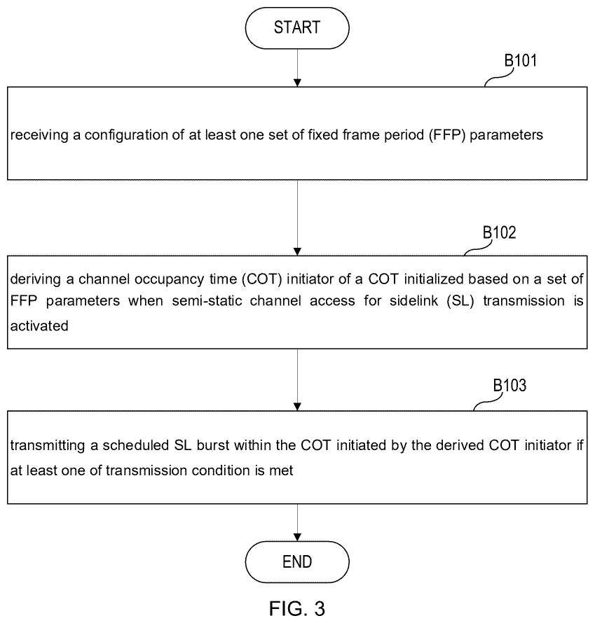

With reference to FIG. 3, a user equipment (UE) (e.g., UE 10a or UE 10b) executes an embodiment of a semi-static channel access method in unlicensed band.

The UE receives a configuration of at least one set of fixed frame period (FFP) parameters (B101).

The UE derives a channel occupancy time (COT) initiator of a COT initialized based on a set of FFP parameters when semi-static channel access for sidelink (SL) transmission is activated (B102).

The UE transmits a scheduled SL burst within the COT initiated by the derived COT initiator if at least one of transmission condition is met (B103).

In some embodiments of the disclosure, the semi-static channel access for SL transmission is activated if the at least one set of FFP parameters is associated with a UE-to-UE communication.

In some embodiments of the disclosure, in the at least one set of FFP parameters, a set of FFP parameters associated with a UE-to-UE communication is separated from a set of FFP parameters associated with a UE-to-base station (BS) communication.

In some embodiments of the disclosure, each of the set of FFP parameters associated with the UE-to-UE communication and the set of FFP parameters associated with the UE-to-base station (BS) communication includes a periodicity of an FFP, and the periodicity of the FFP associated with the UE-to-UE communication is an integer multiple or an integer factor of the periodicity of the set of FFP parameters associated with the UE-to-BS communication.

In some embodiments of the disclosure, in the at least one set of FFP parameters, a common set of FFP parameters is used for both the UE-to-UE communication and UE-to-BS communication.

In some embodiments of the disclosure, each set of FFP parameters in the at least one set of FFP parameters associated with a UE-to-UE communication includes an offset of an FFP, and the offset is determined with respect to a boundary of a SL radio frame.

In some embodiments of the disclosure, the at least one set of FFP parameters is configured per resource block (RB) set or per resource pool.

In some embodiments of the disclosure, the at least one set of FFP parameters is configured per traffic type.

In some embodiments of the disclosure, the traffic type is associated with a priority level.

In some embodiments of the disclosure, the received configuration of the at least one set of FFP parameters includes a set of FFP parameters configured for more than one UE.

In some embodiments of the disclosure, the configuration of the at least one set of FFP parameters is received from a BS or from another UE.

In some embodiments of the disclosure, the UE derives the COT initiator based on information received from a BS or from another UE.

In some embodiments of the disclosure, the information is a resource location of the scheduled SL burst, and the UE derives the COT initiator based on whether the resource location is aligned with a starting point of an FFP configured in the at least one set of FFP parameters.

In some embodiments of the disclosure, the information is a COT initiator indication carried in downlink control information (DCI) or a sidelink channel information (SCI).

In some embodiments of the disclosure, the COT initiator indication can be jointly encoded with resource reservation information in the SCI.

In some embodiments of the disclosure, the COT initiator indication is associated with a UE ID.

In some embodiments of the disclosure, the UE derives a COT initiator based on whether a resource location reserved for the scheduled SL burst transmission is aligned with a starting point of an FFP configured in the at least one set of FFP parameters.

In some embodiments of the disclosure, the UE derives a COT initiator based on whether the COT associated with one of the at least one set of FFP parameters has been initiated by another UE and has been detected by the UE.

In some embodiments of the disclosure, if the derived COT initiator of the COT is the UE, the UE initiates the COT according to one of the at least one set of FFP parameters configured for the UE.

In some embodiments of the disclosure, if the derived COT initiator of the COT is not the UE. the UE uses the COT initiated by another UE.

In some embodiments of the disclosure, the at least one transmission condition is a condition where the scheduled SL burst does not overlap with an idle period of an FFP associated with the at least one set of FFP parameters.

In some embodiments of the disclosure. if the derived COT initiator is not the UE. the at least one transmission condition is a condition where the UE is a qualified UE to use the COT initiated by another UE.

In some embodiments of the disclosure, the UE is a qualified UE to use the COT if a channel access priority class (CAPC) value associated with the UE is equal to or smaller than a CAPC value associated with another UE initiating the COT.

In some embodiments of the disclosure, the UE is a qualified UE to use the COT if the UE is a target receiver UE of another UE initiating the COT.

In some embodiments of the disclosure, the target receiver UE is identified by a destination ID carried in a SCI and transmitted from another UE initiating the COT.

In some embodiments of the disclosure, the UE is a qualified UE to use the COT if a target receiver of the scheduled SL burst transmission from the UE is the another UE initiating the COT.

In some embodiments of the disclosure, a resource of the scheduled SL burst is selected by the UE after performing channel sensing within a sensing window, wherein a duration of the sensing window is determined according to a periodicity or an offset of an FFP associated with the at least one set of FFP parameters.

In some embodiments of the disclosure, the duration of the sensing window is equal to or larger than the periodicity of the FFP.

In some embodiments of the disclosure, a resource of the scheduled SL burst is selected by the UE after performing channel sensing, and the UE does not perform channel sensing during an idle period of an FFP associated with the at least one set of FFP parameters.

In some embodiments of the disclosure, a resource location of the scheduled SL burst is selected by the UE within a selection window, wherein a parameter of the selection window is determined according to a periodicity or an offset of an FFP associated with the at least one set of FFP parameters.

In some embodiments of the disclosure, a resource location of the scheduled SL burst is selected by the UE within a selection window, wherein the selected resource location does not overlap with an idle period of an FFP associated with the at least one set of FFP parameters.

In some embodiments of the disclosure, a resource location of the scheduled SL burst is selected by the UE within a selection window, wherein the selected resource location is aligned with the starting point of an FFP associated with the at least one set of FFP parameters.

In some embodiments of the disclosure, a resource location of the scheduled SL burst is selected and reserved by the UE, a resource reservation interval (RRI) for reserving resources of consecutive transport blocks (TBs) is determined according to a periodicity or an offset of an FFP associated with the at least one set of FFP parameters.

In some embodiments of the disclosure, the RRI is equal to or larger than the periodicity of the FFP.

In some embodiments of the disclosure, the scheduled SL burst transmitted within the COT includes an initial transmission and a retransmission of a TB.

In some embodiments of the disclosure, the scheduled SL burst transmitted within the COT includes either an initial transmission or a retransmission of a TB.

More embodiments of the invention are detailed in the following.

### Embodiment A

Examples of a resource allocation procedure for semi-static channel access in SL-U are provided in the following.

### Embodiment A-0:

gNB (e.g., BS 20a) can configure one or more instances of the following information via radio resource control (RRC) signaling to a UE for supporting semi-static channel access in Mode 1 or Mode 2 resource allocation:
a) Activation of semi-static channel access for SL transmission;
b) One or more than one resource block (RB) set or resource pool for performing semi-static channel access in SL-U; and
c) UE's SL FFP parameters.

Activation of semi-static channel access for SL transmission may include one or more of:
1. Activation of a SL UE for performing COT initiation according to parameters of an FFP for SL transmission; and
2. Activation of a SL UE for performing COT sharing according to parameters of an FFP for SL transmission.

UE's SL FFP parameters may include the periodicity and offset of at least one SL FFP associated with the UE. An SL FFP is an FFP configured for sidelink PC5 interface.

SL FFP parameters assignment can be based on at least one of the following schemes:
1. Each SL UE can be independently configured with at least one set of SL FFP parameters.

AUE can be configured with more than one set of FFP parameters. For example, one set of FFP parameters is used for Uu interface, and another set of FFP parameters is used for PC5 interface. For example. UE is configured with more than one set of FFP parameters to reflect different traffic types for different application scenarios (e.g., service types or usage types).
2. A unified or common set of SL FFP parameters can be assigned to more than one SL UE.

The unified or common set of SL FFP parameters among SL UEs can be predefined in the standard or provided by gNB (e.g., BS 20a) via SIB1 or dedicated RRC signaling.

In addition to SL FFP parameters configured for a SL UE, the SL UE can also receive information of another set of SL FFP parameters associated with another UE. The information of another set of SL FFP parameters associated with another UE can be received by the UE based on at least one of the following schemes:
1. In a first scheme, the set of SL FFP parameters associated with another UE is provided by gNB (e.g., BS 20a) via downlink control information (DCI), medium access control (MAC) control element (CE), or RRC signaling.
2. In a second scheme, the set of SL FFP parameters associated with another UE is provided by another UE via sidelink control information (SCI) or PC5-RRC signaling.

Either a set of SL FFP parameters or corresponding COTs can be explicitly or implicitly associated with a priority level. A UE can determine which set of SL FFP parameters to use or whether the UE can initiate its own COT based on the priority level of a corresponding FFP.

In some embodiments, the priority level of an SL FFP or corresponding COT can be informed by a UE using SCI.

In some embodiments, the priority level of an SL FFP or corresponding COT can be associated with L1 priority or CAPC value of a UE.

In some embodiments, a UE can determine whether to initiate its own COT or share other UE's COT according to the priority level of an SL FFP associated with other UE. For example. the UE refrains from initiating its own COT for accessing scheduled resource if the location of scheduled resource is also overlapped with another UE's COT and the priority level of the COT associated with another UE's FFP has a higher priority.

In addition to SL FFP parameters configured for a SL UE, the SL UE can also receive another set of SL FFP parameters which is unified among SL UEs. A unified SL FFP parameters can be predefined in the standard or provided by gNB (e.g., BS 20a) via SIB1 or dedicated RRC signaling. UE can assume a priority level of the unified set of SL FFP parameters. For example, the priority level of the unified set of SL FFP parameters is the same among SL UEs. For example, the priority level of the unified set of SL FFP parameters has higher priority than the set of SL FFP parameter specifically associated with the UE.

The periodicity of an SL FFP can be determined based on at least one of the following schemes. The periodicity value can be configured with at least one value selected from the set {1, 2, 2.5, 4, 5, 10} milliseconds (ms). The periodicity value of FFP for PC5 interface can be the same or different from the FFP configured for Uu interface (i.e., FFP parameters associated with a gNB (e.g., BS 20a) or a UE for downlink (DL) or uplink (UL) transmission).

In case the periodicity values are not the same, the periodicity of the FFP for PC5 interface can be an integer multiple or an integer factor of the periodicity of the FFP for Uu interface.

An offset of SL FFP (referred to as SL FFP offset) can be determined based on at least one of the following schemes.

In some embodiments, the SL FFP offset is determined with respect to a boundary of a sidelink radio frame. For example, the boundary can be the beginning of an even indexed sidelink radio frame.

In some embodiments, the offset value of an SL FFP can be the same as or different from the offset value of an FFP configured for Uu interface, i.e., an FFP associated with a gNB (e.g., BS 20a) or a UE for DL or UL transmission.

### Embodiment A-1:

gNB (e.g., BS 20a) can receive at least one instance of the following scheduling assistance information from a Tx UE (e.g., one Tx UE in the telecommunication system) to assist Mode 1 resource allocation for semi-static channel access, in order to schedule resources for one or more than one UEs transmitting within a COT.
1. UE's SL FFP parameters.
2. A priority level of SL traffic intended to be transmitted by a UE.
3. UE's capability of initiating a COT or sharing an initiated COT associated with an FFP.
4. A specific frequency range for COT sharing, e.g., indexes of one or more than one RB-based interlace, subchannel, or RB set.
5. Target Rx UE(s), e.g., based on UE ID, for receiving SL PSSCH/PSCCH within a COT associated with the FFP of the Tx UE.
6. SL-HARQ feedback related information.
7. SL channel type(s) to be transmitted on a COT.
8. Resource reservation information.
9. Channel condition related information.

Examples of UE's SL FFP parameters may include at least one of periodicity an offset. For example, the gNB (e.g., BS 20a) can schedule resources according to an FFP associated with a UE.

A specific frequency range for COT sharing may be represented by indexes of one or more than one RB-based interlace, subchannel, or RB set. Interlace is defined in 3GPP related specification.

SL-HARQ feedback related information may include one or more of the following:
1. Activation of SL-HARQ feedback.
2. Feedback timing of SL-HARQ feedback.
3. Cast type of SL-HARQ feedback, e.g., SL unicast or SL groupcast based SL-HARQ feedback.

The SL channel type may include PSCCH, PSSCH, PSFCH, or sidelink synchronization signal block (S-SBB).

For a UE capable of performing Mode 2 resource allocation, resource reservation information can be provided to the gNB (e.g., BS 20a) to avoid resource scheduling collision between the Mode 1 and Mode 2 resource allocation. A UE can report resource reservation information that indicates its own reserved resource or another UE's reserved resource. Another UE's reserved resource can be derived from decoding first stage SCI. The resource reservation information may include time domain resource or frequency domain resource for initial transmission or retransmission of one or more than one TB.

Channel condition related information: gNB (e.g., BS 20a) can rely on the channel condition related information to determine whether to adjust scheduled resource, e.g., an RB set. or to adjust channel access parameters for a UE for a worse channel condition. The channel condition related information may comprise one or more of:
1. SL-HARQ feedback result of SL unicast or SL groupcast;
2. An LBT failure indication; and
3. A channel busy ratio (CBR) or a channel occupancy ratio (CR) measurement.

### Embodiment A-2:

gNB (e.g., BS 20a) can receive scheduling assistance information from a UE based on the following schemes:

The scheduling assistance information can be carried in uplink control information (UCI) over licensed or shared spectrum via physical uplink control channel (PUCCH) or physical uplink shared channel (PUSCH). The scheduling assistance information can be individually encoded in a UCI or jointly encoded with SL HARQ feedback or configured grant UCI (CG-UCI). The scheduling assistance information can be transmitted individually or together with other information that includes at least one of the following:
1. UE assistance information, e.g., an SL traffic type, SL traffic periodicity, SL traffic priority, maximum TB size, or latency and reliability requirement of a TB, via Medium Access Control (MAC) control element (CE) or RRC signaling.
2. Scheduling request (SR) and/or buffer status report (BSR).

### Embodiment A-3:

gNB (e.g., BS 20a) can determine one or more instances of the following information and then perform corresponding scheduling via DCI for Mode 1 resource allocation.
1. Whether more than one slots for data transmission within a COT should be triggered to increase transmission reliability or a data rate for a UE.

In some embodiments, more consecutive slots can be scheduled for a UE with higher priority, such that the UE has more reliable SL transmissions.
2. Cyclic prefix extension (CPE) length of transmissions in a COT.
   A higher priority UE with a longer CPE length can initiate transmission earlier and avoid blockage by transmission from a lower priority UE.
   CPE length can also be used to ensure that the gap between consecutive SL transmission bursts within a COT is at most 16 μs (microsecond).
3. Whether a pair of UEs or a group of UEs can be scheduled within a COT.
   A responding UE (e.g., one of UE 10b or UE 10a) shares a COT initiated by an initiating UE. In an example, a target receiver of an initiating UE's transmission happens to be a UE that sends a scheduling request. When the UE that sends the scheduling request is a responding UE, and one of the target receiver(s) of the responding UE (e.g., one of UE 10b or UE 10a) is the initiating UE, then:
      A first transmission burst can be scheduled for the initiating UE (e.g., one of UE 10a or UE 10b) followed by a second transmission burst scheduled for the responding UE, both occurring within the same COT associated with the initiating UE.
      Since the initiating UE is a target receiver UE of the responding UE, gNB (e.g., BS 20a) can further schedule a third transmission burst for the initiating UE, e.g., for HARQ-ACK feedback, within the same COT.

### Embodiment A-4:

For Mode 1 resource allocation, gNB (e.g., BS 20a) can schedule resources for one or more than one UE within a COT associated with an FFP based on at least one of the following steps. note that the example is not restricted to these steps, and alternative embodiments can be derived by combining, dividing, skipping, or reordering any of the following steps.
Step 1: gNB (e.g., BS 20a) receives SR or BSR from one or more than one UE (e.g., one or both of UE 10a and UE 10b).
Step 2: gNB (e.g., BS 20a) receives scheduling assistance information from the one or more than one UE.
Step 3: gNB (e.g., BS 20a) derives or configures a set of FFP parameters for a UE (referred to as a first UE) that requests a SL resource. The first UE is one UE among the one or more than one UE.
Step 4: gNB (e.g., BS 20a) schedules a first SL transmission burst that starts from the starting point of an FFP associated with the set of parameters and ends before the start of the idle duration of the FFP associated with the first UE. In some embodiments, gNB (e.g., BS 20a) can indicate a CPE length of the first SL transmission burst for the first UE that intends to initiate a COT. In some embodiments. gNB (e.g., BS 20a) can explicitly instruct the Tx UE (i.e., the first UE) to initialize a COT via DCI or implicitly instruct the first UE to initialize a COT by scheduling resources, for the first UE, aligned with the starting point of the FFP associated with the first UE. That is, implicitly instructing the first UE is realized based on whether the scheduled resource is aligned with the starting point of the FFP associated with the first UE. For example, if the resources scheduled by the gNB (e.g., BS 20a) for another UE (referred to as a second UE) are aligned with the starting point of the FFP associated with the first UE, the first UE can initiate a COT associated with the FFP.
Step 5: gNB (e.g., BS 20a) schedules a second SL transmission burst for another UE (referred to as the second UE), The second SL transmission burst starts after the end of the first SL transmission burst and ends before the start of the idle duration of the FFP associated with the first UE. For consecutive transmission within a COT, the gNB (e.g., BS 20a) can indicate to the second UE a CPE length of the second SL transmission burst for the second UE such that the gap between the end of the first transmission burst and the start of the second SL transmission burst is no greater than 16 μs. gNB (e.g., BS 20a) can explicitly instruct the second UE to share an initiated COT or initiate a COT via DCI or implicitly instruct the second UE to share an initiated COT or initiate a COT based on the resource allocation of resources scheduled for the second UE. For example, if the resources scheduled by the gNB (e.g., BS 20a) for the second UE are aligned with the starting point of the FFP associated with the second UE, the second UE can initiate a COT associated with the FFP.
Step 6: gNB (e.g., BS 20a) schedules a third SL transmission burst for the first UE, the third SL transmission burst starts after the end of the second SL transmission burst and ends before the start of the idle duration of the FFP associated with the first UE. The first UE can resume SL transmission of the third SL transmission burst within the COT. For consecutive transmission within a COT, the gNB (e.g., BS 20a) can indicate a CPE length of the third SL transmission burst for the first UE such that the gap between the end of the second transmission burst and the start of the third SL transmission burst is at most 16 μs.
Step 7: gNB (e.g., BS 20a) transmits SL scheduling information to respective UEs which are involved in SL transmissions within a COT based on DCI indication or Type 1/Type 2 configured grant (CG) configuration. Each of the first, second, and third SL transmission burst can include one or more than one consecutive slot for transmitting a single TB, multiple TBs, or SL HARQ feedback. Each of the scheduled slot within a COT is associated with at least one of the following parameters:
An RB set index;
One or more than one subchannel/interlace index or a number of subchannels/interfaces; and
One or more than one symbol location within a slot.

### Embodiment A-5:

For Mode 1 or Mode 2 resource allocation based on semi-static channel access, a UE can initiate a COT or share an initiated COT for a scheduled SL transmission burst based on the following example steps. There is no restriction on the example, and alternative embodiments can be obtained by combining, dividing, skipping, or reordering any of the following steps.
Step 1: For Mode 1 resource allocation, UE (e.g., one of UE 10b or UE 10a) transmits SR or BSR to a gNB (e.g., BS 20a) to request for SL transmission resources.
Step 2: For Mode 1 resource allocation, the UE provides scheduling assistance information to the gNB (e.g., BS 20a).
Step 3: For Mode 1 resource allocation, the UE receives an SL transmission burst scheduling from the gNB (e.g., BS 20a) based on DCI indication or Type 1/Type 2 configured grant (CG) configuration. The gNB schedules or reserves resource for SL transmission burst and uses the DCI indication or the Type 1/Type 2 CG configuration to indicate the scheduled or reserved resource.
   Step 4: For Mode 1 or Mode 2 resource allocation, the UE determines whether to initiate a COT or share an initiated COT for transmitting the scheduled SL transmission burst.

If the scheduled or reserved resource is within a COT of an FFP associated with the UE as well as within a COT of an FFP associated with another UE, the UE determines whether to initiate or share COT based on at least one of the following conditions or their combinations:
1. Scheme 1: UE receives an explicit COT initiator indication from the gNB (e.g., BS 20a) for Mode 1 resource allocation or from the other UE for Mode 2 resource allocation.
2. Scheme 2: Whether the starting location of the scheduled SL transmission burst is aligned with the starting point of the FFP associated with the UE.
3. Scheme 3: Whether a specific COT with a feature has been initiated by the other UE.

Scheme 1 where the UE receives an explicit COT initiator indication from the gNB (e.g., BS 20a) for Mode 1 resource allocation or from the other UE for Mode 2 resource allocation is detailed in the following.

For example, the COT initiator indication can be regarded as part of COT sharing information. The COT initiator indication serves to instruct the UE to initiate a COT (as an initiating UE) or to share an initiated COT (as a responding USER EQUIPMENT (UE).

If the COT initiator is the UE, the UE can initiate a COT, even if the scheduled SL transmission burst is not aligned with the starting point of the FFP associated with the UE.

If the COT initiator is not the UE but rather the other UE, the UE can participate in sharing a COT initiated by the other UE even if the scheduled SL transmission burst is aligned with the starting point of the FFP associated with the UE.

In addition to the COT initiator indication, one or more instances of the following information can also be provided to the UE from the gNB (e.g., BS 20a) for Mode 1 resource allocation or from the other UE for Mode 2 resource allocation as part of the COT sharing information:
One or more than one set of FFP parameters associated with the UE or associated with other UEs;
A CPE length of scheduled SL transmission;
An identity of a target Rx UE (e.g., one or more UEs in the telecommunication system) which is qualified for being a responding UE (e.g., one of UE 10b or UE 10a) associated with a COT initiated by an initiating UE.
A channel access type for a scheduled SL transmission within a COT.
Apriority level of a UE that initiates a COT; and
A priority level of an FFP associated with a Tx UE (e.g., one Tx UE in the telecommunication system).

Scheme 2 regarding whether the starting location of the scheduled SL transmission burst is aligned with the starting point of the FFP associated with the UE is detailed in the following.

If the starting location of the scheduled SL transmission burst is aligned with the starting point of the FFP associated with the UE, at least one of the following schemes can be adopted:
Scheme 2.1: The UE assumes to initiate a COT associated with its one FFP.
Scheme 2.2: If the UE has not detected a COT associated with the other UE has been initiated, the UE can initiate a COT associated with the UE.

If the starting location of the scheduled SL transmission burst is not aligned with the starting point of the FFP associated with the UE, at least one of the following conditions can be adopted:
Scheme 2.3: The UE assumes to share a COT initiated by the other UE. If the COT is not initiated by the other UE, the scheduled transmission burst is dropped.
Scheme 2.4: If the UE has not detected an initiated COT associated with the other UE, the UE can initiate a COT by performing SL transmission at the beginning of the FFP to access the scheduled resource. The UE can initiate a COT by transmitting any SL data, at least within an automatic gain control (AGC) symbol, at the beginning of the FFP associated with the UE.

Scheme 3 regarding whether a specific COT with a feature has been initiated by the other UE is detailed in the following. The feature of the specific COT can be at least one of the following:
The specific COT is associated with an FFP having a lower, equal, or higher priority than the FFP associated with the UE.
The specific COT is associated with an initiating UE (e.g., one of UE 10a or UE 10b) which has a lower, equal to or higher priority than the UE.
The specific COT is associated with a Tx UE (e.g., one Tx UE in the telecommunication system), and the Rx UE (e.g., one or more UEs in the telecommunication system) for receiving SL transmission within the specific COT is a target Rx UE of the Tx UE. For example, the target Rx UE is a UE scheduled for receiving PSCCH/PSSCH transmission from the Tx UE, a UE which can detect SCI from the Tx UE, or a UE of which priority is equal to or higher than the Tx UE.
The specific COT is associated with a unified or a common FFP defined in the standard or preconfigured by a gNB (e.g., BS 20a).

The procedure related to the specific COT can be at least one of the following example procedures:
If the UE has not detected a specific COT that has been initiated by another UE, the UE can initiate a COT associated with its own FFP. Otherwise, if the initiated specific COT has been detected, the UE can share the specific COT initiated by the other UE.
If the UE has not detected a specific COT that has been initiated by another UE or the UE has detected the specific COT that has been initiated by another UE, but the priority level of the specific COT is lower than the UE, then the UE can initiate its own COT. Otherwise, the UE can share the specific COT initiated by the other UE.

The UE can detect or distinguish a COT associated with a FFP associated with Uu interface from a COT associated with a FFP associated with PC5 interface based on at least one of the following criteria. The UE can rely on these criteria to determine whether the detected COT is associated with PC5 interface and therefore can initiate a COT or share an initiated COT for SL transmission.
A resource location or an index of an RB set, which is configured either for Uu interface or PC5 interface.
The set of FFP parameters, i.e., periodicities or offsets, which is configured either for Uu interface or PC5 interface.
The offset of FFP, which is set relative to a frame boundary of either Uu interface or PC5 interface.
Whether an AGC symbol for SL-U can be detected.

The UE determines not to perform SL transmission according to the scheduled resource if at least one of the following conditions is met.
The conditions of initiating a COT associated with the UE's FFP or sharing an initiated COT associated with the other UE's FFP are not satisfied.
The UE fails to access the channel due to LBT failure in an attempt of initiating a COT or sharing an initiated COT.
The scheduled resource is overlapped with the idle period of an FFP. The idle period of an FFP is associated with the UE if a COT is initiated by the UE. The idle period of an FFP is associated with the other UE if a COT initiated by the other UE is shared by the UE.
The UE is not configured with SL FFP parameters for initiating a COT or the UE does not receive the other UE's SL FFP parameters for sharing an initiated COT.
The priority of a UE intended to share an initiated COT is lower than the initiating UE.
   Step 5: Semi-static channel access scheme is performed by the UE for initiating a COT or sharing an initiated COT.

If a UE (e.g., UE 10a or UE 10b) determines to initiate a COT associated with the UE's FFP, the UE initiates a COT after successful LBT for at least 9 μs sensing slot duration and transmits a SL transmission burst from the beginning of the FFP.

If the UE determines to share an initiated COT associated with another UE's FFP, the UE transmits the scheduled SL transmission burst according to a CPE length after successful LBT for at least 9 μs sensing slot duration if the gap between the scheduled SL transmission burst and the previous SL transmission burst is more than 16 μs. Alternatively, the UE transmits the scheduled SL transmission burst according to a CPE length without LBT (Type 2C LBT) if the gap between the scheduled SL transmission burst and the previous SL transmission burst is at most 16μs.

A target Rx UE (e.g., one or more UEs in the telecommunication system) of a responding UE (e.g., one of UE 10b or UE 10a) at least includes the UE functioning as an initiating UE (e.g., one of UE 10a or UE 10b) that initiates the COT. The target Rx UE, i.e., initiating UE, can be identified by the responding UE.

The responding UE (e.g. one of UE 10b or UE 10a) can identify the initiating UE based on the source ID or destination ID indicated in the COT sharing information in the first stage SCI or in the second stage SCI in the PSSCH.

The SL channel transmitted by the responding UE (e.g., one of UE 10b or UE 10a) includes at least one of PSFCH, PSCCH or PSSCH transmissions, which is intended at least for the initiating UE.

A resource reserved by the responding UE (e.g., one of UE 10b or UE 10a) for transmitting a SL transmission burst to the initiating UE is within the COT initiated by the initiating UE.

The destination ID of an SL transmission transmitted from the responding UE (e.g., one of UE 10b or UE 10a) can be indicated in the first stage SCI or the second stage SCI of the responding UE.

If a target UE of the responding UE (e.g., one of UE 10b or UE 10a) is not the UE initiating the COT, at least one of the following criteria can be adopted by the responding UE (e.g., one of UE 10b or UE 10a) to determine the target UE.

The priority of the target UE has an equal or higher priority level than the initiating UE.

The gNB (e.g., BS 20a) or initiating UE (e.g., one of UE 10a or UE 10b) can indicate to the responding UE (e.g., one of UE 10b or UE 10a) whether a SL transmission burst can be transmitted to a target UE other than the initiating UE within a COT initiated by the initiating UE (e.g., one of UE 10a or UE 10b).
Step 6: The initiating UE (e.g., one of UE 10a or UE 10b) can perform another SL transmission burst after receiving a SL burst transmission from the responding UE.

If the gNB (e.g., BS 20a) schedules another SL transmission burst within a COT for the UE initiating the COT based on Mode 1 resource allocation, or the initiating UE (e.g., one of UE 10a or UE 10b) schedules another SL transmission burst within a COT initiated by the UE based on Mode 2 resource allocation.

The initiating UE (e.g., one of UE 10a or UE 10b) transmits another scheduled SL transmission burst according to a CPE length after successful LBT for at least 9 μs sensing slot duration if the gap between the scheduled SL transmission burst and the previous SL transmission burst is more than 16 μs.

The UE transmits another scheduled SL transmission burst according to a CPE length without LBT (Type 2C LBT) if the gap between the other scheduled SL transmission burst and the previous SL transmission burst is at most 16 μs.

The CPE length can be indicated by gNB (e.g., BS 20a) for Mode 1 resource allocation.

### Embodiment A-6:

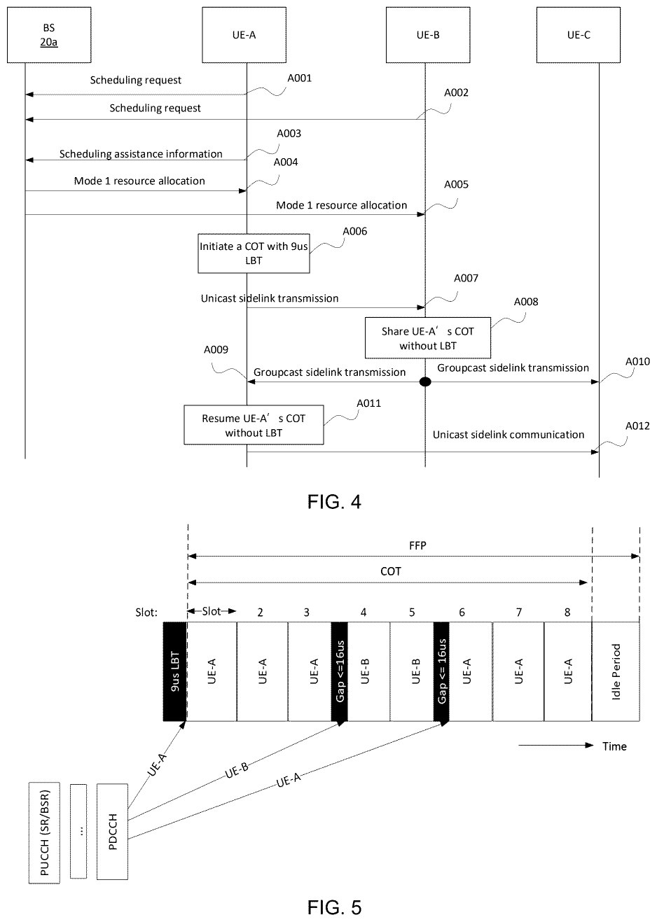

With reference to FIG. 4 and FIG. 5, an example of a signaling flow is provided to demonstrate the relationship between a gNB (e.g., BS 20a) and three UEs for Mode 1 resource allocation based on semi-static channel access.

The BS 20a (e.g., gNB) receives a scheduling request in PUCCH from UE-A (A001) and a scheduling request in PUCCH from UE-B (A002) over a licensed spectrum. The UE 10a and UE 10b are examples of the UE-A and UE-B.

The BS 20a receives scheduling assistance information from UE-A over a licensed spectrum (A003).

The BS 20a transmits physical downlink control channel (PDCCH) to schedule three SL transmission bursts for UE-A and UE-B respectively based on Mode 1 resource allocation (A004 and A005). where the scheduled three SL transmission bursts are within a COT associated with UE-A. In particular, the BS 20a schedules at least two SL transmission bursts for UE-A and one SL transmission burst for UE-8.

UE-A initiates a COT before a scheduled SL transmission burst for UE-A after successful 9 μs LBT (A006) and performs unicast SL transmission to UE-B (A007).

UE-B shares UE-A's COT without LBT (Type 2C LBT) before the scheduled SL transmission burst for UE-B according to a CPE length (A008) and performs groupcast SL transmission to UE-A (A009) and UE-C (A010).

UE-A resumes UE-A's COT without LBT (Type 2C LBT) before a subsequent scheduled SL transmission burst for UE-A (A011) and performs unicast SL transmission to UE-C (A012).

### Embodiment B

To facilitate semi-static channel access for Mode 1 or Mode 2 resource allocation, a Tx UE (e.g., one Tx UE in the telecommunication system) may generate and transmit one or more instances of the following information. The information can be carried in SCI, i.e., first stage SCI or second stage SCI, MAC-CE, or PC5-RRC.

### Embodiment B-1:

Resource reservation information for semi-static channel access.

A reserved resource can be indicated by a UE (referred to as the first UE, such as one of UE 10a or UE 10b) via reservation information in first stage SCI. The reservation information includes time domain resource(s) (e.g., slot index, starting slot location, ending slot location, or a length of consecutive slots, etc.) and frequency domain resource (e.g., subchannel index, interlace index, RB set index, etc.).

The reserved resource can be indicated based on a row index associated with a preconfigured look-up table. Each row in the table has a row index that can be mapped to corresponding parameters in the row associated with a set of resources, e.g., slots or subchannels.

The reserved resource can be located within an FFP or across different FFPs.

The first UE may provide the resource reservation information that reserves a resource belonging to a corresponding FFP which is different from the FFP for transmission of the resource reservation information. In such case, the first UE needs to perform LBT to initiate a COT before accessing reserved resource at the corresponding FFP if the reserved resource is aligned with the starting point of the FFP.

The Tx UE (e.g., one Tx UE in the telecommunication system) can trigger resource reselection if the Tx UE fails to initiate a COT at the corresponding FFP.

If the reserved resource is not aligned with the starting point of FFP associated with the first UE, at least one of the following schemes can be adopted.
Scheme 1: The Tx UE can still initiate a COT by transmitting data for SL initiation (referred to as SL initiation data) at the beginning of the FFP and utilize the reserved resource. The SL initiation data can be any SL channel or SL signal used for initiating a COT. The SL initiation data can be transmitted at least within an AGC symbol at the beginning of the FFP. For example, if the purpose of SL initiation data is used to reserve a COT, then the SL initiation data can be transmitted at the beginning of FFP. For example, if the purpose of SL initiation data is used to reserve a COT, then the SL initiation data can be transmitted from the beginning of FFP up to closing to the starting point of the reserved resource.

The SL initiation data can carry additional information regarding COT sharing. For example, if the purpose of SL initiation data is used to reserve a COT by the first UE and can be identified by other UEs, then other UEs should prevent from sharing a COT initiated with SL initiation data. For example, the SL initiation data can be a predefined set of sequence which can be recognized by other UEs. The SL initiation data can be carried in a PSCCH. For example, the SL initiation data is part of first stage SCI.
Scheme 2: If the reserved resource is within another COT and the first UE has detected that the COT has been initiated by another UE (referred to as a second UE), the first UE shares the initiated COT to utilize the reserved resource. Otherwise, if the COT has not been initiated by the second UE, then the first UE can do at least one of the following:

The first UE stops to transmit on the reserved resource.

The first UE triggers resource reselection or reselects a resource which is aligned with the starting point of an FFP associated with the Tx UE.
Scheme 3: The first UE triggers resource reselection or reselects a resource which is aligned with the starting point of an FFP associated with the Tx UE.

When a responding UE (e.g., one of UE 10b or UE 10a) intends to share a COT initiated by the first UE (e.g., one of UE 10a or UE 10b which serves an initiating UE), the responding UE should receive or be aware of the resource reservation information or FFP parameters associated with the first UE.
During a sensing window, the responding UE (e.g., one of UE 10b or UE 10a) sense resource reservation information, COT sharing information, or FFP parameters in the first stage SCI transmitted by the initiating UE.
During a resource selection window, the responding UE (e.g., one of UE 10b or UE 10a) excludes the resource reserved by the initiating UE as well as the resource overlapped with an idle period of the FFP associated with the initiating UE.
The duration of the sensing window or resource selection window can encompass one or more than one FFP.
The responding UE (e.g., one of UE 10b or UE 10a) can share an initiated COT in at least one of the FFP associated to the initiating UE if at least one of the conditions in Step 4 of Embodiment A-5 is satisfied.

For the second UE intending to initiate a COT, the second UE should receive or be aware of the resource reservation information associated with the first UE or the FFP parameters associated with the second UE.
During a sensing window, the second UE sense the resource reservation information in the first stage SCI transmitted by the first UE.
During a resource selection window, the second UE excludes the resource reserved by the first UE as well as the resource overlapped with an idle period of the FFP associated with the second UE.
The second UE can initiate a COT in at least one of the FFP associated with the second UE if at least one of the conditions in Step 4 of Embodiment A-5 is satisfied.

### Embodiment B-2:

The embodiment illustrates a procedure of Mode 2 resource allocation and resource reservation for semi-static channel access associated with Embodiment B-1.

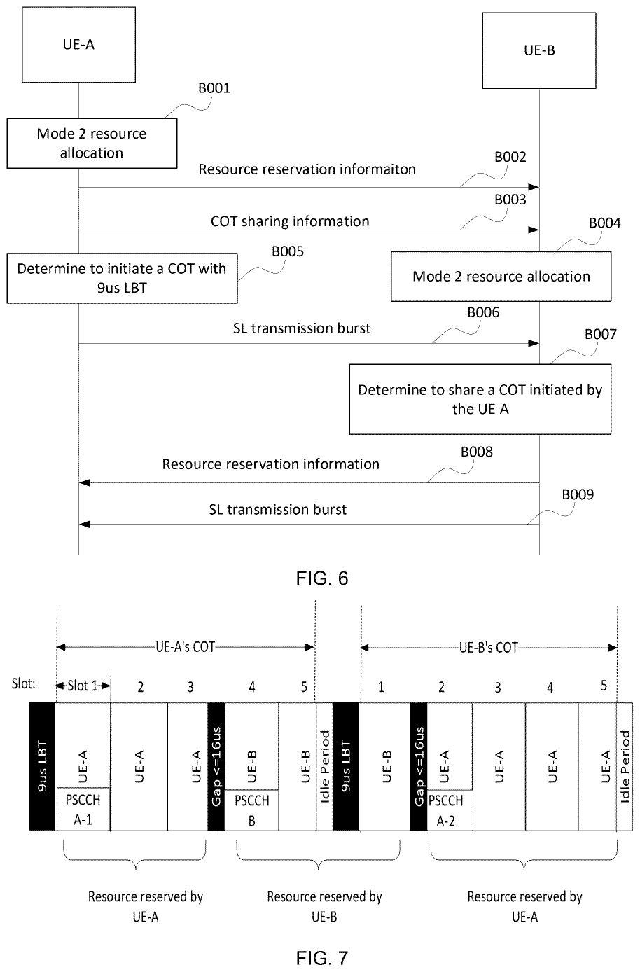

With reference to FIG. 6. UE A (e.g., UE 10a) performs Mode 2 resource allocation (B001).

UE A provides resource reservation information in the first stage SCI of UE A (B002).

UE A provides COT sharing information (B003), e.g., FFP parameters associated with UE A, IDs of target Rx UEs of UE A, or allowance of COT sharing, in the first stage SCI or second stage SCI to other UEs including UE B (e.g., UE 10b).

UE B performs Mode 2 resource allocation based on the received resource reservation information and COT sharing information (B004).

UE B selects resources by excluding the resource reserved by UE A and the resource overlapped with an idle period of FFP associated with the UE A.

UE A determines to initiate a COT before the reserved resource according to a condition regarding, such as whether the reserved resource is aligned with the FFP boundary associated with UE A (B005).

UE A transmits an SL transmission burst (B006), and UE B is a target receiver for receiving the SL transmission burst and therefore is qualified for sharing the COT initiated by UE A.

UE B determines to share (B007) the COT initiated by UE A for accessing a resource reserved by UE B according to a condition, for instance, whether the COT can be shared by other UEs, as indicated in the COT sharing information.

UE B transmits an SL transmission burst to UE A after successfully sharing the COT (B009).

UE B also provides resource reservation information associated with the transmitted SL transmission burst in the first stage SCI of UE B (B008).

### Embodiment B-3: Restrictions on Sharing a COT to Other UEs.

An Tx UE (e.g., one Tx UE in the telecommunication system) can transmit a COT indication to indicate whether a Rx UE (e.g., one or more UEs in the telecommunication system) is allowed or enabled to share an initiated COT or initiate the Rx UE's COT based on at least one of the following schemes:
1. An explicit COT indication. The explicit indication activates or deactivates a COT sharing or a COT initiation via first stage SCI or second stage SCI.

Indication of COT sharing allows a Rx UE (e.g., one or more UEs in the telecommunication system) to share the COT initiated by the Tx UE before the starting point of an idle period associated with the FFP of the Tx UE.

Indication of COT initiation allows a Rx UE (e.g., one or more UEs in the telecommunication system) to initiate its own COT if a resource scheduled in a COT region associated with the Rx UE is overlapped with a COT region associated with Tx UE.
2. The COT indication can be jointly encoded with, correlated with, or implicitly determined from one or more instances of the following information:
Target Rx UE identity information; and
Resource reservation information.

Target Rx UE identity information:

For example, the target Rx UE is the Rx UE qualified for being a responding UE. That is, the Rx UE can share the COT initiated by the Tx UE if the Rx UE is the target receiver of the Tx UE. The target Rx UE of the Tx UE can be one of the following:
The Rx UE is capable of detecting Tx UE's first stage SCI in PSCCH.
An ID of the Rx UE matches the destination ID indicated in the second stage SCI of PSSCH sent from the Tx UE. The destination ID can be a UE-specific ID of a single target UE in unicast transmission or a group-specific ID of a group of target UEs in groupcast transmission.
An ID of the Rx UE matches an ID indicated in the first stage SCI, the ID is defined for one or more than one UE qualified for sharing the COT.
A CAPC value of the Rx UE is equal to or smaller than the CAPC value of the Tx UE.
L1 priority of the Rx UE is equal to or smaller than the L1 priority of the Tx UE.

Resource reservation information:

For example, the FFPs overlapped with the resource reserved by the Tx UE are intended for being initiated by the Tx UE, and the Rx UE can share an initiated COT associated with these FFPs.

For example, the Rx UE can initiate its own COT if its FFPs is not overlapped with the resource reserved by the Tx UE.
3. The COT indication can be an implicit indication of whether a Tx UE has initiated a COT via SL transmission from the beginning of an FFP.

For example, the Rx UE has selected a SL resource within a selection window, but does not detect a SL transmission from the beginning of an FFP associated with the Tx UE that covers the selected SL resource. In this case, the Rx UE can initiate its own COT associated with its FFP on the selected resource. Otherwise, the Rx UE can share the COT initiated by the Tx UE if allowed.

A target receiver of a Rx UE sharing a COT initiated by the Tx UE, i.e., responding UE, includes at least the Tx UE. The Rx UE can Identify the Tx UE based on a source ID or destination ID indicated in the first stage SCI or the second stage SCI sent from the Tx UE.

The SL channel used for transmitting in the shared COT including PSCCH, PSSCH, PSFCH, or S-SSB, wherein at least one of the receivers for receiving these SL channels or SL signals is the Tx UE.

### Embodiment B-4:

With reference to FIG. 7, an example is provided to elucidate the steps involved in Mode 2 resource allocation. The Illustration assumes that both UE-A and UE-B utilize identical FFP parameters, such as a 5 ms periodicity, particularly in the context of semi-static channel access.

UE-A (e.g., UE 10a) performs Mode 2 resource allocation to preclude resources reserved by UE-B and reserves 2 resources for scheduling 2 SL bursts of multi-consecutive slots in the first FFP and the second FFP, respectively.

UE-A initiates a COT associated with the first FFP after successful 9 μs LBT before the first reserved resource and transmits the first SL burst in the first reserved resource.

UE-B (e.g., UE 10b) detects that the COT associated with the first FFP that covers the resource reserved by the UE-B has been initiated by UE-A.

UE-B shares the COT initiated by the UE-A and transmits a SL burst during the shared COT associated with the first FFP. Wherein at least one of the target receivers of the transmitted SL burst is UE-A.

UE-B initiates a COT associated with the second FFP after successful 9 μs LBT before the reserved resource in the first slot and transmits a SL burst in the first slot of the second FFP.

UE-A detects that the COT associated with the second FFP that encompasses the second resource reserved by the UE-A has been initiated by UE-B.

UE-A shares the COT initiated by the UE-B and transmit a second SL burst during the shared COT. At least one of the target receivers of the transmitted SL burst is UE-B.

### Embodiment C (Determination of Sensing Window Parameters)

For Mode 2 resource allocation in NR V2X, a UE decodes multiple instances of first stage SCI received from other UEs during the sensing window to identify non-reserved resources. The sensing window is an interval defined by the range of slots [n-T₀, n-T_{proc,0}], where n is the time point for triggering resource selection upon arrival of a data packet. T₀ is expressed in terms of number of slots, which has an equivalent value of 1100 ms or 100 ms depending on the subcarrier spacing (SCS) configuration. T_{proc,0} is the time required to complete the sensing procedure with a value selected from {1,2,2,4} slot for SCS of {15, 30, 60, 120} kHz, respectively. The UE also measures the reference signal received power (RSRP) of the transmissions associated with the first stage SCIs. Information of reserved resource in the first stage SCI and corresponding RSRP measurements are used for the Tx UE to determine candidate resources during the selection window.
For SL-U, at least one of the above parameters associated with the range of slots can be further determined by the Tx UE based on at least one of the following schemes.
   The value of T₀, T_{proc,0}, or a duration within a sensing window [n-T₀, n-T_{proc,0}] for channel sensing can be determined by the Tx UE based on at least one of the following parameters:
1. Periodicity or an offset of an FFP. The FFP can be associated with a UE that performs sensing or associated with a UE that provides resource reservation information.
2. A location of COT duration or an idle period of a corresponding FFP. The FFP can be associated with a UE that performs sensing or associated with a UE that provides resource reservation information.
3. A channel sensing location or required sensing slot duration for performing LBT for semi-static channel access.
4. SCS configured for a resource pool or an RB set.

The RSRP measurement of the transmissions associated with the first stage SCIs includes the RSPR measurement over PSCCH that carries the first stage SCI or RSPR measurement over the scheduled PSSCH in one or more than one slot in one or more than one FFP. The idle period of an FFP can be precluded from RSRP measurement.

The UE can perform periodic sensing according to the periodicity of an FFP. An idle period of an FFP can be precluded from channel sensing.

### Embodiment D-1 (Determination of Selection Window Parameters)

For Mode 2 resource allocation in NR V2X, if resource selection is triggered at time point n, a selection window is defined for a UE to select candidate resources for transmitting a TB. The selection window includes slots in the range of [n+T₁, n+T₂]. T₁ is the processing time of slots required to identify candidate resources and perform resource selection. T₁ is equal to or smaller than T_{proc,1}. T_{proc,1} equals to 3, 5, 9 or 17 slots for a SCS of 15, 30, 60 or 120 kHz, respectively. The value of T₂ is in the range of T₂ₘᵢₙ≤T₂≤PDB, where PDB is the Packet Delay Budget. The value of T₂ₘᵢₙ depends on the priority of the TB and the SCS. For example, a value of T₂ₘᵢₙ may be j*2^{μ} slots, where j is a value selected from {1,5,10,20}, μ=0,1,2, or 3 corresponds to the SCS of 15, 30, 60, or 120 kHz, respectively.

For SL-U, at least one of the above parameters can be further determined by the Tx UE based on at least one of the following schemes:
Scheme 1: The value of T₁ can further incorporate required channel sensing time, e.g. 9 μs, to complete semi-static LBT procedure.
Scheme 2: The value of T₁ or T₂ can be determined by the Tx UE according to the offset or periodicity of an FFP associated with the UE that performs resource selection. For example, T₁ or T₂ can align with the boundary of an FFP. For example, T₁ or T₂ can be an integer number of FFPs.

### Embodiment D-2 (Determination of Resource Selection Parameters):

For Mode 2 resource allocation in NR V2X, during the selection window, resource selection can be based on dynamic or semi-persistent schemes. In NR V2X, the dynamic scheme selects resources for a TB and can only reserve resources for the initial transmission and retransmissions of that TB. The semi-persistent scheme involves selecting resource of initial transmission and retransmissions for more than one TB.

In NR V2X, two steps resource selection procedure is adopted. In the first step, a UE excludes the candidate resources in the selection window due to half-duplex limitation, wherein resources are excluded when a UE cannot sense the resource reservations from other UEs, as announced in the first stage SCIs, while the UE is transmitting during the sensing window. In addition, UE evaluates the available resources based on the resource reservation information in the first stage SCIs from other UEs during the sensing window. And the resources are excluded if a measured RSRP over the PSCCH carrying the first stage SCI or a measured RSRP associated PSSCH scheduled by PSCCH is higher than an SL-RSRP threshold. To ensure the percentage of available candidate resources in the selection window is at least equal to X %, SL-RSRP threshold can be increased by 3 dB, and the first step is repeated iteratively to meet the X percentage requirement. Depending on the priority of traffic for transmission, possible values of X can be 20, 35, or 50.

In the second step, the UE randomly selects the SL resource from a list of available candidate resources to perform initial transmission and re-transmissions of a TB.

For semi-persistent schemes, the time period between the resources selected for the transmission of consecutive TBs is defined by the Resource Reservation Interval (RRI) or Resource Reservation Period (Pᵣₛᵥₚ), and the number of TBs for consecutive TBs is determined by an SL resource reselection counter. The possible values of the RRI are {0, [1:99], 100, 200, 300, 400 500, 600, 700, 800, 900, 1000} ms. The frequency domain resource for each of consecutive TBs is the same. The UE can select the RRI autonomously based on the characteristics of the traffic type. The number of SL resource reselection counter is randomly determined within an interval according to the selected RRI value. For RRI≥100 ms, the interval is [5,15], and if RRI<100 ms, the interval is [5*(100/max(20,RRI)), 15*(100/max(20,RRI))].

In SL-U, for Mode 2 resource allocation, a percentage of available candidate resources in the selection window X % or the SL-RSRP threshold can be determined based on CAPC value of the traffic transmitted by Tx UE (e.g., one Tx UE in the telecommunication system) or a priority level of the Tx UE.

In SL-U, for Mode 2 resource allocation, the candidate resources or selection of resource in the second step can be further determined based on at least one of following restrictions:

The resource fully or partially overlapped with an idle period is precluded to be selected as a candidate resource. The resource aligning with the starting point of an FFP associated with the UE that performs resource selection can be determined as a candidate resource or selected as a reserved resource.

For a UE that intends to initiate a COT, the UE can select resource for a SL transmission burst such that the selected resource can be aligned with the FFP boundary associated with the initiating UE.

In SL-U, for Mode 2 resource allocation, in order to support SL burst transmission for a TB or multiple TBs within an FFP or across multiple FFPs. At least one of the above parameters can be further determined based on at least one of the following schemes.

The value of Resource Reservation Interval (RRI) can be determined based on as least one of the following schemes.

The Resource Reservation Interval (RRI) can be set to a value that leads to consecutive slots transmissions.

The value of Resource Reservation Interval (RRI) can be determined based on periodicity of an FFP associated with the UE that performs resource selection. For example. RRI is equal to or larger than the periodicity of an FFP. For example, RRI can be integer multiples of the periodicity of an FFP. For example, the periodicity of an FFP can be integer multiples of RRI. The value of Resource Reservation Interval (RRI) is determined based on a duration of time required for performing LBT for semi-static channel access. For example, RRI is larger than the required time duration for performing LBT for semi-static channel access and at least one period of FFP.

In SL-U, for Mode 2 resource allocation, the allocated resource may optionally exhibit one or more of the following characteristics.

The frequency domain resource or adopted MCS in each slot of a SL burst within a COT can be the same or different.

Resource locations of the initial and retransmissions of a TB can be selected to be transmitted within a COT associated with an FFP, or to be transmitted in COTs of different FFPs.

Resource locations of the transmissions of multiple TBs can be selected to be transmitted within a COT associated with an FFP, or to be transmitted in COTs of different FFPs.

### Embodiment E (Resource Selection for Multiple Consecutive Slots)

In NR V2X, for the dynamic scheduling scheme based on the Mode 2 resource allocation, resources can be reserved for a TB. including initial transmission and the retransmissions of that TB. The granularity of candidate resource is defined by a slot in time and contiguous sub-channels in frequency.

In SL-U, in order to support multiple consecutive slots transmission for the dynamic or semi-static static channel access based on Mode 2 resource allocation, the resource structure of a candidate resource can be defined as one of the following.

Resource structure of a candidate resource can be multiple consecutive slots in time within a COT, wherein each slot can have a different number of subchannels or interfaces. The physical layer can report multiple sets of candidate consecutive slots to the MAC layer. The MAC layer can select at least one set of consecutive slots among multiple sets of candidate consecutive slots. Each layer may be software program module or integrated circuit (IC) entity or unit for performing corresponding function of the layer according to 3GPP related standards.

For semi-static channel access, the determination of a set of candidate consecutive slots by physical layer or selection of a set of consecutive slots by MAC can be based on at least one of the following:
1. The set of consecutive slots is within a COT of an FFP.

The set of consecutive slots does not across an idle period of an FFP.
2. If the set of consecutive slots across an idle period of an FFP, the set of consecutive slots can be split into more than one subset of consecutive slots, and at least one of the following dropping schemes is adopted.
The slot covering the idle period is dropped.
The resource of a slot covering the idle period is dropped.
3. The starting point of the set of consecutive slots is aligned with the beginning of an FFP.
4. The length of consecutive slots can be determined based on latency requirement, TB size or priority level.

### Embodiment F (Scheduling Multi-Consecutive Slots for a TB)

In SL-U, in order to support multi-consecutive slots scheduling based on Mode 1 or Mode 2 resource allocation, a TB can associate with one PSSCH or more than one PSSCH, i.e., PSSCH repetition or blind retransmission.

For a single TB case, initial transmission and blind retransmissions of a TB can be carried in the same set of multi-consecutive slots within an FFP or in the different sets of multi-consecutive slots across different FFPs.

Type B repetition for PSCCH/PSSCH, similar to PUSCH in NR-U, can be adopted for multi-consecutive slots transmission of a TB in SL-U. Each of the nominal repetition of a PSCCH/PSSCH transmission with repetition type B can be located within a same FFP or across different consecutive FFPs.

For scheduling of Type B repetition, if a UE transmits a nominal repetition of a PSCCH/PSSCH transmission with repetition type B, and the nominal repetition is associated with a COT shared by the UE or initiated by the UE, at least one of the followings is applicable if the nominal repetition is overlapped with an idle period:
1. If the UE determined that the nominal repetition is associated with a COT of an FFP that is initiated by another UE or initiated by the UE itself, and if the nominal repetition overlaps with an idle period corresponding to the FFP, symbols during the idle period are considered as invalid symbols, and at least one of following mechanisms can be adopted:
The nominal repetition is dropped.
The nominal repetition is segmented to at least one actual repetition, and the actual repetition after the idle period is dropped.
The nominal repetition is segmented to at least one actual repetition, and each of actual repetitions is transmitted by the UE.
The actual repetition after the idle period is within a COT of an FFP associated with the UE that performs the Type B repetition.
2. For scheduling of Type B repetition, the number of subchannels/interlaces or subchannel/interlace index for each nominal repetition can be the same or different. The index of subchannels/interlaces can be continuous for more than one subchannel/interlace.
3. For scheduling of Type B repetition, the number of repetitions and corresponding resource locations can be preconfigured for a resource pool or an RB set.
4. For scheduling of Type B repetition, if a nominal repetition crosses a slot boundary or invalid symbol(s), the nominal repetition can be skipped or can be segmented into one or more actual repetitions. For example, a nominal repetition can be segmented into a first actual repetition located before the invalid symbol(s) and a second actual repetition located after the invalid symbol(s).

The invalid symbol(s) includes at least one of the following:
A guard symbol at the end of a SL slot.
A guard symbol before the AGC symbol of PSFCH in a SL slot.
Any symbol or slot which is not configured for SL communication.
Idle period of an FFP.

If an actual repetition only contains one symbol, e.g. an orphan symbol, due to segmentation, then the following transmission scheme for the orphan symbol can be adopted:
The orphan symbol is not transmitted.
The orphan symbol is transmitted as a demodulation reference signal (DMRS) symbol.
The orphan symbol is transmitted in a way similar to an AGC symbol, i.e., as a copy of the next symbol in the same slot.
The orphan symbol is transmitted as a CPE of a subsequent symbol that follows the orphan symbol.

### Embodiment G

For Mode 1 or Mode 2 resource allocation for dynamic or semi-static channel access, a PSFCH occasion for PSFCH feedback is preconfigured per resource pool or per RB set, or dynamically indicated.

According to the PSSCH-to-PSFCH feedback timing restriction, the PSFCH feedback may be within a COT carrying the scheduled PSSCH or within a different COT.
1. If the PSFCH occasions are preconfigured:

If the COT is initiated by a Tx UE, the Rx UE can transmit PSFCH on a slot with a preconfigured PSFCH occasion after successfully sharing the Tx UE's COT. If the COT is initiated by a Rx UE, the Rx UE can transmit PSFCH on a slot with a preconfigured PSFCH occasion after successfully initiating the COT.

Either the Tx UE (e.g., one TX UE in the telecommunication system) or Rx UE can reserve a resource for PSFCH transmission by transmitting resource reservation information in the SCI, wherein the reserved resource includes slots with a PSFCH occasion for PSFCH transmission.

For the case of Tx UE reserves a resource for PSFCH transmission, if a preconfigured PSFCH occasion is overlapped with resource reserved by the Tx UE, the Rx UE can still access the PSFCH occasion for PSFCH transmission. That is, the PSFCH occasions located in the reserved resource can be an exceptional case for resource exclusion in Type 2 resource allocation.

If the PSFCH feedback timing is outside of a COT carrying the scheduled PSSCH, the PSFCH transmission can be transmitted on the earliest slot with a PSFCH symbol at a later COT if PSFCH occasions are preconfigured. The later COT can be associated with the Tx UE or Rx UE. The Rx UE can transmit PSFCH within Tx UE's COT if the COT has been initiated by the Tx UE. The Rx UE can initiate a COT and transmit PSFCH within Rx UE's COT if a PSFCH occasion is within a COT associated with the TX UE, but the COT associated with the TX UE has not been initiated.

If the resource of the later COT has been reserved by the Tx UE or Rx UE, then a COT for transmitting PSFCH can be initiated or shared accordingly. Otherwise, the Tx UE or Rx UE needs to reserve a resource covering the PSFCH occasions in corresponding COTs.
2. If the PSFCH occasion (e.g., within a slot) associated with a slot is dynamically indicated by the Tx UE via first stage SCI or second stage SCI, the RX UE transmits PSFCH in the slot indicated by the Tx UE after successfully accessing the channel.

Either the Tx UE or Rx UE can reserve a resource and initiate a COT before or within the reserved resource at the indicated slot for PSFCH transmission. If the resource for PSFCH transmission is reserved by the Tx UE, the Rx UE determines to transmit PSFCH at the indicated slot regardless of whether the Rx UE has reserved the resource. The resource reserved by the Tx UE can be overlapped with the resource indicated for PSFCH transmission.

If the dynamic PSFCH feedback indication can also be received by another UE (referred to as the second UE), at least one of the following operations can be adopted by the second UE.
The second UE can refrain from performing SL transmission or preclude the resource selection on the indicated resource to avoid collision with the PSFCH feedback transmission.
The second UE can jointly transmit its PSFCH on the indicated PSFCH resource. The resource location or resource index of PSFCH for transmitting on a PSFCH symbol can be determined by the second UE based on the source ID or destination ID in the first stage SCI or in the second stage SCI.

The Tx UE can firstly detect and sense the resource reservation information transmitted by the Rx UE, such that the Tx UE can be aware of the resource reserved by the Rx UE, and then indicates to Rx UE a slot for PSFCH transmission within the reserved resource. The indicated slot can be within the resource reserved by the Rx UE, and the location of the reserved resource at least includes a slot with a PSFCH occasion. The Tx UE or the Rx UE can initiate a COT within the resource reserved by the Rx UE.

The Tx UE can firstly detect and sense the resource reservation information transmitted by the Rx UE such that the indicated slot can be outside the resource reserved by the Rx UE. The indicated slot can be within the resource reserved by the Tx UE, and the reserved resource at least includes a slot with a PSFCH occasion.

The slot location indicated for PSFCH transmission in a PSFCH occasion can be dynamically indicated. The PSFCH symbol location within a slot can be preconfigured or dynamically indicated by a dynamic indication.

If the PSFCH feedback is outside of a COT carrying the scheduled PSSCH associated with the PSFCH feedback, the following applies.

The dynamic indication can indicate a resource for PSFCH transmission in a later COT.

The dynamic indication can also indicate an initiator of a COT to the Rx UE.

If the initiator is the Tx UE, the Tx UE should initiate a COT for Rx UE to share the COT initiated by the Tx UE. The Rx UE transmits PSFCH at a PSFCH occasion of a slot indicated by Tx UE.

If the initiator is the Rx UE, the Rx UE can initiate its own COT for transmitting PSFCH at a PSFCH occasion of a slot indicated by Tx UE.

### Embodiment H: Semi-Static Channel Access Mode With Multi-Channel Transmission or Transmission of Multiple SL RB Sets in SL-U

A UE may be scheduled or (pre)configured by a gNB (e.g., BS 20a) to transmit one or more SL transmissions on multiple SL channels or multiple SL RB sets. The one or more than one SL transmission includes PSSCH, PSCCH, PSFCH, or S-SSB.

In an embodiment, the multiple SL channels or multiple SL RB sets are located within a carrier bandwidth of a carrier or a SL bandwidth part of a carrier.

In an embodiment, the UE should perform independent LBTs according to semi-static channel access procedure in each channel. either to initiate a COT in order to access a channel if the COT has not been initiated or to share an initiated COT in order to access a channel if the COT has been initiated.

A PSSCH or a PSCCH may be transmitted over multiple SL channels. If the UE fails to access any of the SL channels, the UE ceases transmission of the PSSCH or PSCCH on all of the multiple SL channels.

Multiple PSFCHs or S-SSBs may be transmitted over multiple SL channels, and each PSFCH or S-SSB is transmitted on one of multiple SL channels. UE can transmit the PSFCHs or S-SSBs on one or more SL channels of multiple SL channels when the UE can successfully access the one or more SL channels. The multi-channel procedure used for DL transmission in NR-U, including Type A or Type B, can be reused for SL-U.

A PSSCH or a PSCCH may be transmitted over a subset of multiple SL channels. The UE can transmit the PSSCH or PSCCH on the subset of multiple SL channels when the UE can successfully access each channel of the subset of multiple SL channels. The subset of multiple SL channels includes one or more than one SL channels. The multi-channel procedure used for DL transmission in NR-U, including Type A or Type B, can be reused for SL-U.

The CPE length of each of the transmitted SL channels can be the same. The CPE length can be (pre)configured or indicated by the gNB (e.g., BS 20a).

For a UE has successfully accessed each channel of the SL channels, if a SL transmission is overlapped with at least one idle period of the SL channels, the UE can perform at least one of the following:
UE stops transmitting on all of the SL channels.
UE stops transmitting on the SL channels overlapped with at least one idle period.

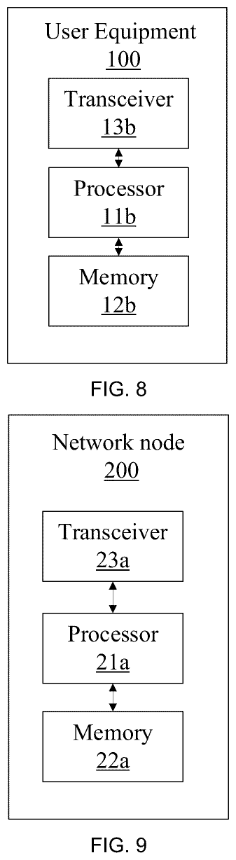

With reference to FIG. 8, the UE 100 may include a processor 11a, a memory 12a, and a transceiver 13a. The processor 11a is configured to call and run a computer program stored in the memory 12a, to cause UE 100 in which the processor 11 is installed to execute the disclosed method, steps, and/or functions of a UE. The UE 100 is an example of the UE in the description (e.g., UE 10a or UE 10b). The transceiver 13a may include baseband circuitry and radio frequency (RF) circuitry.

With reference to FIG. 9, the network node 200 is a network device and may include a processor 21a, a memory 22a, and a transceiver 23a. The processor 21a is configured to call and run a computer program stored in the memory 22a, to cause network node 200 in which the processor 11 is installed to execute the method, steps, and/or functions of a network node. The network node 200 is an example of CN network entity, network node, radio node, the base station, or gNB in the description. The transceiver 23a may include baseband circuitry and radio frequency (RF) circuitry.

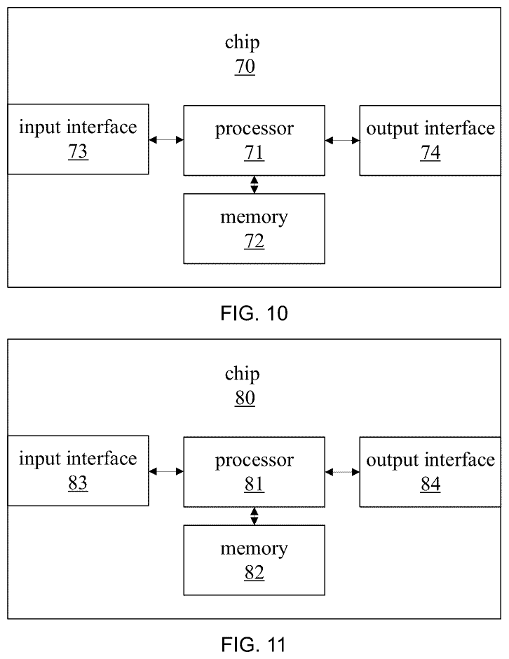

With reference to FIG. 10, the embodiment of the disclosure also provides a chip 70 that may correspond to a UE in the embodiments of the disclosure. The chip 70 may implement a corresponding process realized by the UE in various methods of the embodiments of the disclosure. The chip 70 includes a processor 71, and the processor 71 may call and run a computer program from memory to implement the methods in the embodiments of the present application.

Optionally, the chip 70 may also include a memory 72. In particular, the processor 71 may call and run the computer program from the memory 72 to implement the methods in the embodiments of the present application.

Moreover, the memory 72 may be a separate device from the processor 71 or may be integrated into the processor 71.

Optionally, the chip 70 may further include an input interface 73. Note that the processor 71 may control the input interface 73 to communicate with other devices or chips, specifically, to obtain messages or data sent by other devices or chips.

Optionally, the chip 70 may further include an output interface 74. Note that the processor 71 may control the output interface 74 to communicate with other devices or chips, specifically, to output messages or data to other devices or chips.

With reference to FIG. 11, the embodiment of the disclosure also provides another chip 80 that may correspond to a network device (e.g., CN network entity, network node, radio node, the base station, or gNB) in the description, and the chip 80 may implement the corresponding processes implemented by the network device in the various methods of the embodiments of the disclosure. The chip 80 includes a processor 81, and the processor 81 may call and run a computer program from the memory 82 to implement the methods in the embodiments of the present application.

Optionally, the chip 80 may further include a memory 82. In particular, the processor 81 may call and run the computer program from the memory 82 to implement the methods in the embodiments of the present application.

Wherein the memory 82 may be a separate device from the processor 81 or may be integrated into the processor 81.

Optionally, the chip 80 may also include an input interface 83. In particular, the processor 81 may control the input interface 83 to communicate with other devices or chips, specifically, to obtain messages or data sent by other devices or chips.

Optionally, the chip may further include an output interface 84. In particular, the processor 81 may control the output interface 84 to communicate with other devices or chips, specifically, to output messages or data to other devices or chips.

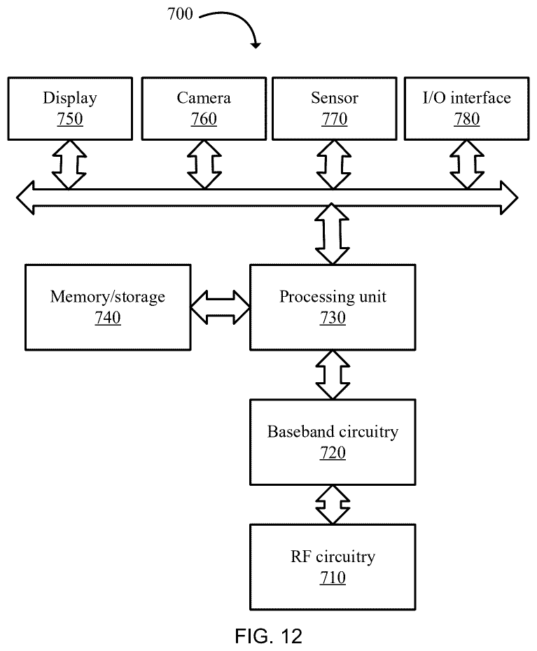

FIG. 12 is a block diagram of an example system 700 for wireless communication according to an embodiment of the present disclosure. Embodiments described herein may be implemented into the system using any suitably configured hardware and/or software. FIG. 12 illustrates the system 700 including a radio frequency (RF) circuitry 710, a baseband circuitry 720, a processing unit 730, a memory/storage 740. a display 750. a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the UE, eNB, or gNB (e.g., BS 20a) 20 may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated. or group), and/or memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for the system. The memory/storage for one embodiment may include any combination of suitable volatile memory, such as dynamic random access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port. a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that may be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of the application and design requirement for a technical plan. A person having ordinary skill in the art may use different ways to realize the function for each specific application while such realizations should not go beyond the scope of the present disclosure. It is understood by a person having ordinary skill in the art that he/she may refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure may be realized in other ways. The above-mentioned embodiments are exemplary only. The division of the units is merely based on logical functions while other divisions exist in realization. It is possible that a plurality of units or components are combined or integrated into another system. It is also possible that some characteristics are omitted or skipped. On the other hand, the displayed or discussed mutual coupling, direct coupling, or communicative coupling operates through some ports, devices, or units, whether indirectly or communicative in ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments may be integrated into one processing unit, physically independent, or integrated into one processing unit with two or more than two units.

If the software function unit is realized and used and sold as a product, it may be stored in a readable storage medium in a computer. Based on this understanding, the technical plan proposed by the present disclosure may be essentially or partially realized as the form of a software product. Or, one part of the technical plan beneficial to the conventional technology may be realized as the form of a software product. The software product in the computer is stored in a storage medium, including a plurality of commands for a computational device (such as a personal computer, a server 41, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A semi-static channel access method in unlicensed band for execution by a user equipment (UE), comprising:
receiving a configuration of at least one set of fixed frame period (FFP) parameters;
deriving a channel occupancy time (COT) initiator of a COT initiated based on a set of FFP parameters when semi-static channel access for sidelink (SL) transmission is activated; and
transmitting a scheduled SL burst within the COT initiated by the derived COT initiator if at least one transmission condition is met.

2. The semi-static channel access method of claim 1, wherein the semi-static channel access for SL transmission is activated if the at least one set of FFP parameters is associated with a UE-to-UE communication.

3. The semi-static channel access method of claim 1, wherein in the at least one set of FFP parameters, a set of FFP parameters associated with a UE-to-UE communication is separated from a set of FFP parameters associated with a UE-to-base station (BS) communication.

4. The semi-static channel access method of claim 3, wherein each of the set of FFP parameters associated with the UE-to-UE communication and the set of FFP parameters associated with the UE-to-base station (BS) communication includes a periodicity of an FFP, and the periodicity of the FFP associated with the UE-to-UE communication is an integer multiple or an integer factor of the periodicity of the set of FFP parameters associated with the UE-to-BS communication.

5. The semi-static channel access method of claim 1, wherein in the at least one set of FFP parameters, a common set of FFP parameters is used for both the UE-to-UE communication and UE-to-BS communication.

6. The semi-static channel access method of claim 1, wherein each set of FFP parameters in the at least one set of FFP parameters associated with a UE-to-UE communication includes an offset of an FFP, and the offset is determined with respect to a boundary of a SL radio frame.

7. The semi-static channel access method of claim 1, wherein the at least one set of FFP parameters is configured per resource block (RB) set or per resource pool.

8-10. (canceled)

11. The semi-static channel access method of claim 1, wherein the configuration of the at least one set of FFP parameters is received from a BS or from another UE.

12. The semi-static channel access method of claim 1, wherein the UE derives the COT initiator based on information received from a BS or from another UE.

13. The semi-static channel access method of claim 12, wherein the information is a resource location of the scheduled SL burst, and the UE derives the COT initiator based on whether the resource location is aligned with a starting point of an FFP configured in the at least one set of FFP parameters.

14. The semi-static channel access method of claim 12, wherein the information is a COT initiator indication carried in downlink control information (DCI) or a sidelink channel information (SCI).

15. The semi-static channel access method of claim 14, wherein the COT initiator indication can be jointly encoded with resource reservation information in the SCI.

16. The semi-static channel access method of claim 14, wherein the COT initiator indication is associated with a UE ID.

17. (canceled)

18. The semi-static channel access method of claim 1, wherein the UE derives a COT initiator based on whether the COT associated with one of the at least one set of FFP parameters has been initiated by another UE and has been detected by the UE.

19-20. (canceled)

21. The semi-static channel access method of claim 1, wherein the at least one transmission condition is a condition where the scheduled SL burst does not overlap with an idle period of an FFP associated with the at least one set of FFP parameters.

22. The semi-static channel access method of claim 1, wherein if the derived COT initiator is not the UE, the at least one transmission condition is a condition where the UE is a qualified UE to use the COT initiated by another UE.

23-26. (canceled)

27. The semi-static channel access method of claim 1, wherein a resource of the scheduled SL burst is selected by the UE after performing channel sensing within a sensing window, wherein a duration of the sensing window is determined according to a periodicity or an offset of an FFP associated with the at least one set of FFP parameters.

28-31. (canceled)

32. The semi-static channel access method of claim 1, wherein a resource location of the scheduled SL burst is selected by the UE within a selection window, wherein the selected resource location is aligned with the starting point of an FFP associated with the at least one set of FFP parameters.

33-41. (canceled)

42. A semi-static channel access method in unlicensed band for execution by a base station, comprising:
transmitting a configuration of at least one set of fixed frame period (FFP) parameters;
transmitting scheduling information of a sidelink (SL) burst within a channel occupancy time (COT) of an FFP associated with the at least one set of FFP parameters; and
receiving SL hybrid automatic repeat request (HARQ) feedback that responds to transmission of the scheduled SL burst.

43. The semi-static channel access method of claim 42, wherein the at least one set of FFP parameters is configured for a first UE, the COT is initiated by the first UE according to the at least one set of FFP parameters, the scheduled SL burst is transmitted form the first UE to a second UE, and the SL HARQ feedback is received from the second UE.

44-51. (canceled)
